(19) United States
(12) Patent Application Publication
(10) Pub. No.: US 2020/0320274 A1
(43) Pub. Date: Oct. 8, 2020

(54) ENCODER, IMAGE PROCESSING SYSTEM, UNMANNED AERIAL VEHICLE AND ENCODING METHOD

(71) Applicant: SZ DJI TECHNOLOGY CO., LTD., Shenzhen (CN)

(72) Inventors: Yaqiang WANG, Shenzhen (CN); Dong QIN, Shenzhen (CN)

(21) Appl. No.: 16/910,827

(22) Filed: Jun. 24, 2020

Related U.S. Application Data
(63) Continuation of application No. PCT/CN2017/118265, filed on Dec. 25, 2017.

(51) Int. Cl. G06K 9/00; G06K 9/62; B64C 39/02

(52) U.S. Cl. CPC G06K 9/0063; B64C 2201/127; B64C 39/024; G06K 9/6202

(57) ABSTRACT

An encoder includes a first processing circuit and a second processing circuit. The first processing circuit is configured to perform intraframe prediction on a sub-image-block according to reconstructed neighboring pixels of the sub-image-block to determine an optimal intraframe prediction direction of the sub-image-block. The second processing circuit is configured to generate quantized data of the sub-image-block according to the optimal intraframe prediction direction of the sub-image-block, and perform reconstruction on the sub-image-block according to the quantized data of the first sub-image-block. The sub-image-block is one of sub-image-blocks for processing obtained by dividing a to-be-encoded image block in a division mode.

### CROSS-REFERENCE TO RELATED APPLICATION

This application is a continuation of International Application No. PCT/CN2017/118265, filed Dec. 25, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the image encoding and decoding field and, more particularly, to an encoder, an image processing system, an unmanned aerial vehicle (UAV), and an encoding method.

### BACKGROUND

Image encoding and decoding technology may be used to compress an image. Conventional image compression methods include intraframe compression and interframe compression. The process of the intraframe compression includes processes of intraframe prediction, residual encoding, reconstruction, etc.

An objective of the intraframe prediction is to choose an optimal intraframe prediction direction from a predetermined plurality of intraframe prediction directions. An intraframe prediction of a sub-image-block (or block) usually needs to be performed based on neighboring pixels of the sub-image-block.

One type of existing technology uses intraframe prediction based on reconstructed pixels of the neighboring pixels of the sub-image-block. This type of intraframe prediction method has high prediction accuracy but introduces data dependence between the sub-image-blocks. Due to the data dependence between the sub-image-blocks, the existing technology usually processes each of the sub-image-blocks in sequence based on a sub-image-block numbering sequence. As a result, the intraframe compression process cannot be pipelined.

### SUMMARY

In embodiments of the present disclosure, there is provided an encoder including a first processing circuit and a second processing circuit. The first processing circuit is configured to perform intraframe prediction on a sub-image-block according to reconstructed neighboring pixels of the sub-image-block to determine an optimal intraframe prediction direction of the sub-image-block. The second processing circuit is configured to generate quantized data of the sub-image-block according to the optimal intraframe prediction direction of the sub-image-block, and perform reconstruction on the sub-image-block according to the quantized data of the first sub-image-block. The sub-image-block is one of sub-image-blocks for processing obtained by dividing a to-be-encoded image block in a division mode.

In embodiments of the present disclosure, there is provided an image processing system including an encoder. The encoder includes a first processing circuit and a second processing circuit. The first processing circuit is configured to perform intraframe prediction on a sub-image-block according to reconstructed neighboring pixels of the sub-image-block to determine an optimal intraframe prediction direction of the sub-image-block. The second processing circuit is configured to generate quantized data of the sub-image-block according to the optimal intraframe prediction direction of the sub-image-block, and perform reconstruction on the sub-image-block according to the quantized data of the first sub-image-block. The sub-image-block is one of sub-image-blocks for processing obtained by dividing a to-be-encoded image block in a division mode.

In embodiments of the present disclosure, there is provided an encoding method. The encoding method includes performing intraframe prediction on a sub-image-block according to reconstructed neighboring pixels of the sub-image-block to determine an optimal intraframe prediction direction of the sub-image-block, generating quantized data of the sub-image-block according to the optimal intraframe prediction direction of the sub-image-block, and performing reconstruction on the sub-image-block according to the quantized data of the first sub-image-block. The sub-image-block is one of sub-image-blocks for processing obtained by dividing a to-be-encoded image block in a division mode.

### BRIEF DESCRIPTION OF THE DRAWINGS

FIG. 1 illustrates a schematic flowchart of an intraframe compression method.

FIG. 2 illustrates an exemplary diagram of a to-be-encoded image block.

FIG. 3 illustrates a schematic structural diagram of an encoder according to some embodiments of the present disclosure.

FIG. 4 illustrates a schematic diagram of an encoding sequence after adjustment according to some embodiments of the present disclosure.

FIG. 5 illustrates an exemplary diagram of an operation manner of a pipeline according to some embodiments of the present disclosure.

FIG. 6 illustrates a schematic structural diagram of an encoder according to some other embodiments of the present disclosure.

FIG. 7 illustrates a schematic diagram showing a manner of setting a suspension threshold according to some embodiments of the present disclosure.

FIG. 8 illustrates a schematic structural diagram of an image processing system according to some embodiments of the present disclosure.

FIG. 9 illustrates a schematic structural diagram of an unmanned aerial vehicle (UAV) according to some embodiments of the present disclosure.

FIG. 10 illustrates a schematic flowchart of an encoding method according to some embodiments of the present disclosure.

### DETAILED DESCRIPTION OF THE EMBODIMENTS

Embodiments of the present disclosure may be applied to various image or video encoding and decoding technologies, such as advanced video coding (H.264), high-efficiency video coding (H.265), etc. Embodiments of the present disclosure may be applied to various application fields that need to perform image encoding and decoding and/or video transmission, such as fields of image transmission of an unmanned aerial vehicle (UAV), mobile photography, high-definition (HD) surveillance field, etc.

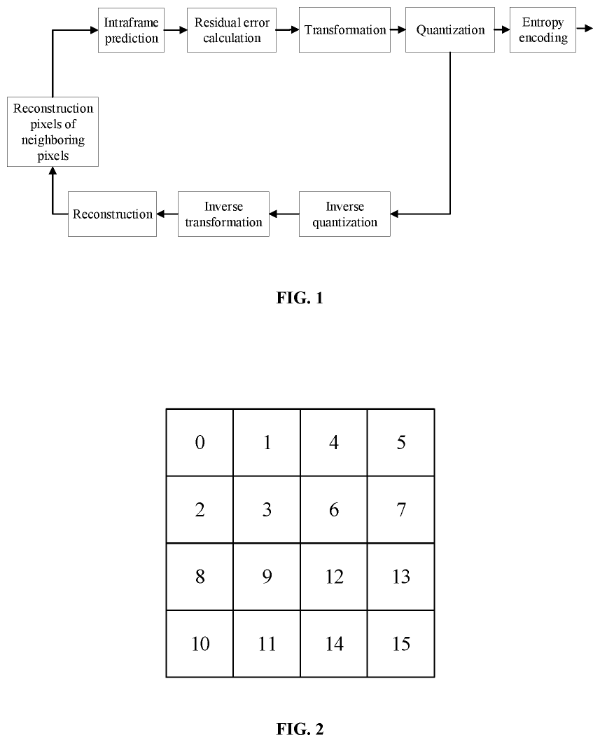

FIG. 1 schematically shows an intraframe compression process according to H.264.

H.264 uses a 16×16 macroblock as a unit to perform the intraframe compression on the image. Within a macroblock, the finer intraframe prediction and/or compression are performed according to the following three division modes, such as block4×4, block8×8, and block16×16. As shown in FIG. 1, the process of the intraframe compression includes intraframe prediction (the intraframe prediction can be further divided into sub-processes such as intraframe prediction direction search, matching cost calculation, etc.), residual error calculation, transformation (such as discrete cosine transformation), quantization, entropy encoding, etc. The process of the intraframe compression further includes performing inverse processes, such as inverse quantization, inverse transformation, reconstruction, etc., on a quantization result of the block to determine reconstructed pixels of the block.

The intraframe prediction is performed based on the neighboring pixels of the block. In some embodiments, reconstructed pixels of neighboring pixels of a certain block are used as a reference for the intraframe prediction of the block. In this disclosure, a reconstructed pixel of a neighboring pixel is also referred to as a “reconstructed neighboring pixel.” As such, great image compression quality can be obtained, but data dependence between block data is introduced, resulting in low intraframe compression efficiency for the image. This is described in more detail below in connection with FIG. 2, using the block4×4 division mode as an example.

FIG. 2 shows a 16×16 macroblock. The macroblock is divided into 16 blocks (sub-image-blocks) based on the block4×4 division mode. In some embodiments, the reconstructed pixels of the neighboring pixels of the block are used as the reference of the intraframe prediction. Since the intraframe prediction of a next block of each block needs to use reconstructed pixels of a current block as a reference, next block calculation can only start after current block calculation is completed. For example, in FIG. 2, the intraframe prediction needs to rely on the neighboring pixels in the left, upper left, upper, upper right, and other directions of block 6 as prediction references. Therefore, the intraframe compression process of block 6 may only start after the reconstruction processes of block 1, block 2, block 3, block 4, and block 5 are completed. Thus, in FIG. 2, the 16 4×4 blocks usually are processed in sequence according to the numbering sequence, and pipeline design is not applicable to hardware resources of the encoder. As such, the limited hardware resource may not be able to be fully used to achieve high-performance processing.

In some other embodiments, original pixels of neighboring pixels of a certain block may be used as a reference for the intraframe prediction of the block. Since the original pixels of each block exist naturally, the start of the intraframe compression of a block is not related to whether the reconstructions of the neighboring blocks are completed. Therefore, this method may release the data dependence among the blocks, such that the pipeline design may be applicable to the process of the intraframe compression, and even parallel processing is possible. However, the original pixels are similar to the reconstructed pixels, and the difference therebetween may reduce the image compression quality.

Nowadays, middle and low-end products usually use the original pixels of the neighboring pixels of the block as the intraframe prediction reference of the block. As such, high hardware performance is easily achieved, but the image compression quality is sacrificed. High-end products usually use the reconstructed pixels of the neighboring pixels of the block as the intraframe prediction reference of the block. As such, a better image compression quality may be achieved, but the intraframe compression efficiency is reduced.

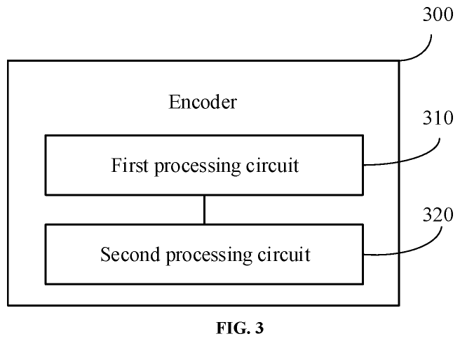

Embodiments of the present disclosure provide an encoder, which can improve the intraframe compression efficiency by maintaining the image compression quality. FIG. 3 illustrates a schematic structural diagram of an encoder 300 according to some embodiments of the present disclosure, which is described in detail below.

The encoder 300 can be an on-chip coding system performing an image encoding function. The encoder 300 includes a first processing circuit 310 and a second processing circuit 320. The first processing circuit 310 and a second processing circuit 320 are two independent hardware modules, and can communicate with each other (e.g., using semaphore mechanism for communication).

In the present disclosure, unless processing targets of a processing circuit (e.g., the first processing circuit, and the second processing circuit, or a third processing circuit and a fourth processing circuit described below) are specified as luma blocks or chroma blocks, the present disclosure does not limit the types of the sub-image-blocks processed by the processing circuit, which may be luma blocks or chroma blocks.

The processing process of the first sub-image-block is used as an example for describing the functions of the first processing circuit 310 and the second processing circuit 320 in detail. The first sub-image-block may include a sub-image-block of a to-be-encoded image block in the first division mode. In this disclosure, sub-image-blocks obtained by dividing the to-be-encoded image block in the first division mode are also referred to as first sub-image-blocks for processing. Embodiments of the present disclosure do not limit a size of the to-be-encoded image block and the first division mode, which are related to the encoding standard on which the encoder 300 is based.

H.264 is taken as an example, the to-be-encoded image block may include a 16×16 image block (or referred to as macroblock). The first division mode may include a 4×4 division mode. Therefore, the first sub-image-block may include any one image block of the sub-image-blocks numbered 1, 3, 4, 6, 9, and 12 (for the corresponding relationship of the image blocks and the numbering, refer to FIG. 2).

H.265 is taken as an example, the to-be-encoded image block may include a 64×64 image block. The first division mode may include a division mode of 16×16, 8×8, or 4×4. For example, the first division mode includes the 16×16 division mode. The first sub-image-block may include any one image block of the sub-image-blocks numbered 1, 3, 4, 6, 9, and 12.

The first processing circuit 310 may be configured to perform the intraframe prediction on the first sub-image-block according to the reconstructed pixels of the neighboring pixels of the first sub-image-block to determine an optimal intraframe prediction direction of the first sub-image-block.

For example, the first processing circuit 310 executes operations corresponding to the intraframe prediction shown in FIG. 1. For example, the matching cost may be calculated for the first sub-image-block in various intraframe prediction directions. An intraframe prediction direction with the smallest matching cost is selected as the optimal intraframe prediction direction of the first sub-image-block.

The second processing circuit 320 may be configured to generate quantized data of the first sub-image-block according to the optimal intraframe prediction direction of the first sub-image-block, and perform the reconstruction on the first sub-image-block according to the quantized data of the first sub-image-block.

For example, in FIG. 1, the second processing circuit 320 executes the operations of residual error calculation, transformation, quantization, inverse quantization, inverse transformation, reconstruction, etc. For example, for the processing process of the first sub-image-block, the second processing circuit 320 obtains information indicating the optimal intraframe prediction direction of the first sub-image-block from the first processing circuit 310, and execute following operations in sequence based on the optimal intraframe prediction direction of the first sub-image-block: performing the residual error calculation on the first sub-image-block based on the optimal intraframe prediction direction of the first sub-image-block to obtain residual error data, performing the transformation on the residual error data to obtain transformed data, performing the quantization on the transformed data to obtain the quantized data of the first sub-image-block, performing the inverse quantization on the quantized data of the first sub-image-block to obtain the inverse quantized data of the first sub-image-block, and performing the inverse transformation and reconstruction on the inverse quantized data of the first sub-image-block to obtain the reconstructed pixels of the first sub-image-block. In some embodiments, the second processing circuit 320 is further configured to execute entropy encoding operation shown in FIG. 1.

The first processing circuit 310 may be further configured to, in response to receiving a first indication signal, perform the intraframe prediction on the second sub-image-block according to the reconstructed pixels of the neighboring pixels of the second sub-image-block to determine an optimal intraframe prediction direction of the second sub-image-block. The first indication signal indicates completion of the reconstruction of the first sub-image-block. The first processing circuit 310 may further be configured to, in response to receiving the first indication signal, perform the intraframe prediction on a third sub-image-block according to the reconstructed pixels of the neighboring pixels of the third sub-image-block to determine an optimal intraframe prediction direction of the third sub-image-block.

The second sub-image-block and the third sub-image-block are sub-image-blocks of the to-be-encoded image block in the first division mode. The second sub-image-block is a right sub-image-block of the first sub-image-block. The third sub-image-block is a bottom left sub-image-block of the first sub-image-block. H.264 is taken as an example, in FIG. 2, assume that the first sub-image-block is sub-image-block 1, then the second sub-image-block and the third sub-image-block are sub-image-block 4 and sub-image-block 2, respectively. As another example, assume that the first sub-image-block is sub-image-block 12, then the second sub-image-block and the third sub-image-block are sub-image-block 13 and sub-image-block 11, respectively. The intraframe prediction may be performed on the second sub-image-block and the third sub-image-block in parallel or in sequence, which is not limited by embodiments of the present disclosure. The parallel processing of the second sub-image-block and the third sub-image-block may improve the intraframe compression efficiency.

The specific processing manners performed by the first processing circuit 310 on the second sub-image-block and the third sub-image-block are similar to the processing manner performed by the first processing circuit 310 on the first sub-image-block. Reference may be made to the above description and the description is not repeated here.

Further, the second processing circuit 320 may be configured to, in response to receiving a second indication signal, generate quantized data of the second sub-image-block according to the optimal intraframe prediction direction of the second sub-image-block, and perform the reconstruction on the second sub-image-block according to the quantized data of the second sub-image-block. The second indication signal indicates the completion of the intraframe prediction of the second sub-image-block. The second processing circuit 320 may further be configured to, in response to receiving a third indication signal, generate the quantized data of the third sub-image-block according to the optimal intraframe prediction direction of the third sub-image-block, and perform the reconstruction on the third sub-image-block according to the quantized data of the third sub-image-block. The third indication signal indicates the completion of the intraframe prediction of the third sub-image-block

The specific processing manners performed by the second processing circuit 320 on the second sub-image-block and the third sub-image-block are similar to the processing manner performed by the second processing circuit 320 on the first sub-image-block. Reference may be made to the above description and the description is not repeated here.

When the intraframe compression is performed based on the reconstructed pixels of the neighboring pixels of the sub-image-block, due to the restriction of the data dependence among the sub-image-blocks, the conventional technology usually uses a serial processing manner to process each of the sub-image-blocks. That is, after one sub-image-block is reconstructed, only the intraframe prediction and reconstruction process of a next image block of the sub-image-block can be started.

In the to-be-encoded image block, if the first sub-image-block (e.g., sub-image-blocks 1, 3, 4, 6, 9, or 12 in FIG. 2) has a right sub-image-block and a bottom left sub-image-block, then after the first sub-image-block is reconstructed, the reconstructed pixels of the neighboring pixels of the right sub-image-block and the bottom left sub-image-block of the first sub-image-block are obtained. Therefore, unlike the existing technology, the present disclosure does not perform serial processing on the sub-image-blocks according to the numbering sequence of the sub-image-blocks, but changes the processing sequence of the sub-image-blocks as follows. After the first sub-image-block is reconstructed, a sub-image-block at the right side of the first sub-image-block and a sub-image-block at the bottom left of the first sub-image-block are both determined as the to-be-processed sub-image-blocks. Further, the method of the present disclosure includes performing the intraframe prediction on the sub-image-blocks by the first processing circuit, and quantizing and reconstructing the sub-image-blocks by the second processing circuit. The first processing circuit is equivalent to a prediction pipeline stage of the sub-image-blocks, which is used for intraframe prediction of the sub-image-blocks, and the second processing circuit is equivalent to a reconstruction pipeline stage of the sub-image-blocks, which is used to quantize and reconstruct the sub-image-blocks. The two pipeline stages exchange information needed by each other through the indication signals. The prediction pipeline stage and the reconstruction pipeline stage are introduced to realize the pipeline design of the intraframe compression process and improve the intraframe compression efficiency.

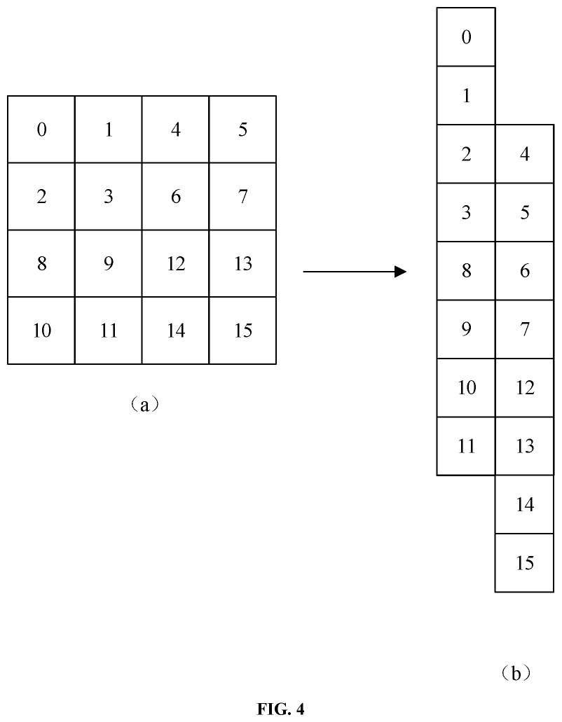

FIG. 4 to FIG. 6 show an example of the processing processes of the prediction pipeline stage and the reconstruction pipeline stage by using a 16×16 image block as the to-be-encoded image block and a block4×4 division mode as the first division mode.

Part (a) of FIG. 4 shows blocks 0-15. Based on data dependence relationship among blocks 0-15, after the reconstructed pixels of block 1 are determined, the reconstructed pixels of the neighboring pixels needed by the right side sub-image-block, block 4, and the bottom left sub-image-block, block 2, of block 1 for the intraframe prediction are obtained. After the reconstructed pixels of block 4 are determined, the reconstructed pixels of the neighboring pixels needed by the right side sub-image-block, block 5, and the bottom left sub-image-block, block 3, of block 4 for the intraframe prediction are obtained. After the reconstructed pixels of block 6 are determined, the reconstructed pixels of the neighboring pixels needed by the right side sub-image-block, block 7 and the bottom left sub-image-block, block 9, of block 6 for the intraframe prediction are obtained. After the reconstructed pixels of block 9 are determined, the reconstructed pixels of the neighboring pixels needed by the right side sub-image-block, block 12 and the bottom left sub-image-block, block 10, of block 9 for the intraframe prediction are obtained. After the reconstructed pixels of block 12 are determined, the reconstructed pixels of the neighboring pixels needed by the right side sub-image-block, block 13 and the bottom left sub-image-block, block 11, of block 12 for the intraframe prediction are obtained.

Based on the above analysis, the present disclosure adjusts the calculation sequence of the 16 blocks shown in part (a) of FIG. 4 to the calculation sequence shown in part (b) of FIG. 4, that is, block 0→block 1→blocks 2, 4→blocks 3, 5→blocks 8, 6→blocks 9, 7→blocks 10, 12→blocks 11, 13→block 14→block 15. In the present disclosure, this calculation sequence is also referred to as a calculation sequence base on wavefront.

According to the present disclosure, pipeline design is applied to the calculation processes of the 16 blocks. The calculation process of each of the 16 blocks is divided into a prediction pipeline stage performed by the first processing circuit 310 and a reconstruction pipeline stage performed by the second processing circuit 320. The prediction pipeline stage may calculate the optimal intraframe prediction direction of each block based on the reconstructed pixels of the neighboring pixels of the block. The reconstruction pipeline stage may perform processes of residual error calculation, transformation, quantization, inverse quantization, inverse transformation, reconstruction, etc., based on the optimal intraframe prediction direction of the block.

Within each of the two pipeline stages, a certain mechanism, such as a state machine mechanism, may be used to process the various blocks in sequence. Further, the reconstruction pipeline stage needs to depend on information output by the prediction pipeline stage, and the prediction pipeline stage also needs to depend on information output by the reconstruction pipeline stage. Therefore, the two pipeline stages may communicate with each other to exchange the information needed by each other through a certain communication mechanism. For example, the two pipeline stages may be interactively controlled by semaphores. The reconstruction pipeline stage depends on the semaphores output by the prediction pipeline stage. The prediction pipeline stage depends on the semaphores output by the reconstruction pipeline stage. The control circuits of the two pipeline stages read respective start semaphores according to the predetermined sequence, and write respective output semaphores.

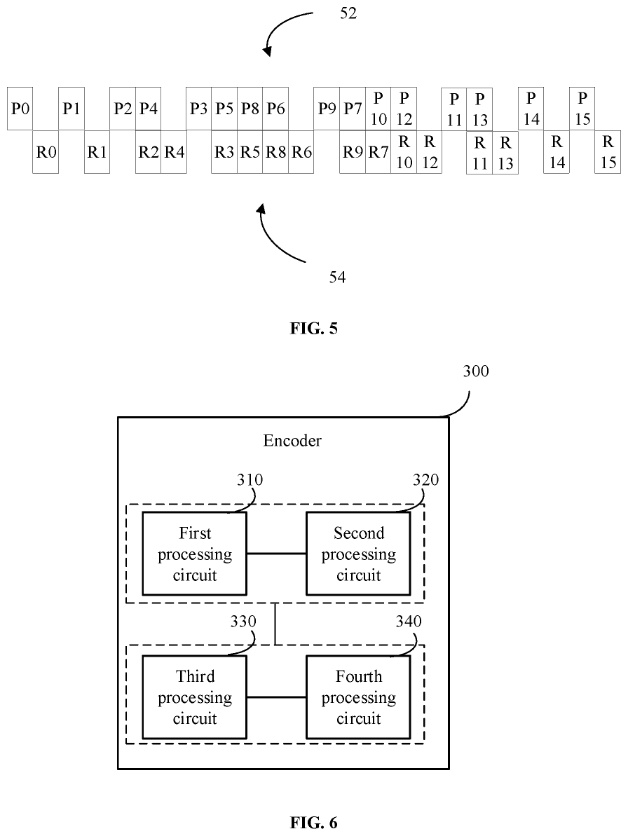

FIG. 5 illustrates an exemplary diagram of an operation method of a pipeline according to some embodiments of the present disclosure. In FIG. 5, the pipeline includes a prediction pipeline stage 52 and a reconstruction pipeline stage 54. The calculation process of the prediction pipeline stage 52 includes P0-P15. Pi performs the prediction on the block numbered i. The calculation process of the reconstruction pipeline stage 54 includes R0-R15. Rj performs the quantization and reconstruction on the block numbered j. According to FIG. 5, without additional hardware resources, P4, P5, P8, P6, P7, P10, P12, and P13 are fully pipelined, the bubbles are compressed in the pipeline, and the parallel processing is realized. Consistent with the present disclosure, the processing of the block4×4 sub-image-blocks is pipelined based on the wavefront calculation sequence, the parallel processing for the block4×4 is realized, and the calculation efficiency of the encoder is improved.

As described above, the to-be-encoded image block generally needs to use a plurality of division modes to perform the intraframe prediction and select an optimal division mode (e.g., the division mode with the smallest matching cost) as the final division mode for the to-be-encoded image block. For example, for H.264, the to-be-encoded image block is a 16×16 image block. The 16×16 image block needs to perform intraframe prediction in the three division modes of block4×4, block8×8, and block16×16. The encoder needs to select the optimal division mode from the above three division modes as the final division mode for the to-be-encoded image block.

To reduce power consumption, the suspension threshold may be pre-configured. If an accumulated value of division cost of a block under a certain division mode is greater than the suspension threshold, this division mode is not the optimal division mode. Under this situation, the encoder may stop the subsequent calculation in this division mode to reduce the power consumption of the encoder. However, the suspension threshold of the related technology is normally an experience value or a statistic value, which may not be adaptively adjusted according to different encoding situations.

FIG. 6 shows another example of the encoder 300 consistent with the disclosure, which can adaptively adjust the suspension threshold according to the different situations. The structure and function of the encoder 300 are described in detail below.

In the example shown in FIG. 6, the encoder 300 includes the first processing circuit 310, the second processing circuit 320, a third processing circuit 330, and a fourth processing circuit 340.

The first processing circuit 310 may be configured to perform the intraframe prediction on each of the sub-image-blocks in the first division mode. The second processing circuit 320 may be configured to perform the quantization and reconstruction on each of the sub-image-blocks of the to-be-encoded image block in the first division mode. The first processing circuit 310 and the second processing circuit 320 are described above in detail, and are not repeated here.

The third processing circuit 330 may be configured to perform the intraframe prediction on each of the sub-image-blocks of the to-be-encoded image block in a second division mode. In this disclosure, sub-image-blocks obtained by dividing the to-be-encoded image block in the second division mode are also referred to as second sub-image-blocks for processing. The fourth processing circuit 340 may be configured to perform the quantization and reconstruction on each of the sub-image-blocks of the to-be-encoded image block in the second division mode.

The first processing circuit 310 and the second processing circuit 320 are equivalent to a hardware processing channel corresponding to the first division mode, and are configured to process each of the sub-image-blocks of the to-be-encoded image block in the first division mode. The third processing circuit 330 and the fourth processing circuit 340 are equivalent to a hardware processing channel corresponding to the second division mode, and are configured to process each of the sub-image-blocks of the to-be-encoded image block in the second division mode. Therefore, consistent with the present disclosure, different hardware processing channels are used to process the sub-image-blocks corresponding to the first division mode and the second division mode, respectively.

Consistent with the present disclosure, a size of the sub-image-block obtained by division under the second division mode is greater than the size of the sub-image-block obtained by division under the first division mode.

For example, for H.264, the to-be-encoded image block may include a 16×16 image block. The first division mode may include a block4×4 division mode. The second division mode may include a block8×8 division mode, or a block16×16 division mode.

For example, for H.265, the to-be-encoded image block may be a 64×64 image block. The first division mode may include a block4×4 division mode, and the second division mode may include a block64×64 division mode. In some embodiments, the first division mode may include a block16×16 division mode, and the second division mode may include a block32×32 or block64×64 division mode.

The first processing circuit 310 and/or the second processing circuit 320 may further be configured to stop processing the to-be-encoded image block, when the current division cost (e.g., a sum of the division costs of the currently calculated sub-image-blocks in the first division mode) of the to-be-encoded image block corresponding to the first division mode is greater than or equal to the total division cost (e.g., a sum of the matching costs of the sub-image-blocks in the second division mode).

The size of the sub-image-block obtained by division under the second division mode is greater than the size of the sub-image-block obtained by division under the first division mode. Therefore, compared to a number of the sub-image-blocks obtained by division under the first division mode, a number of the sub-image-blocks obtained by division under the second division mode is less. Therefore, the calculation process of the sub-image-block in the second division mode may be completed earlier. After the calculation process of the sub-image-block in the second division mode is completed, the total division cost corresponding to the second division mode is used as the suspension threshold to control the processing process of the sub-image-block in the first division mode. For different encoding situation or to-be-encoded image, the total division cost corresponding to the first division mode is different. Therefore, embodiments of the present disclosure may adaptively change the suspension threshold according to the different encoding situation or to-be-encoded image to make the configuration of the suspension threshold more accurate.

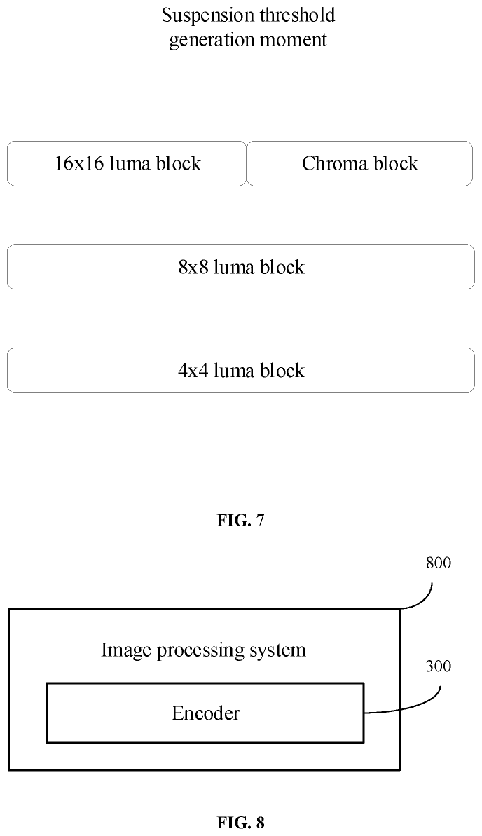

As shown in FIG. 7, for example, the to-be-encoded image block is a 16×16 image block, and a luma component of the to-be-encoded image block needs to be divided in three forms of block4×4, block8×8, and block16×16. For distinction purposes, the sub-image-block obtained by dividing the luma component of the to-be-encoded image block in the block4×4 division mode is referred to as a 4×4 luma block. The sub-image-block obtained by dividing the luma component of the to-be-encoded image block in the block8×8 division mode is referred to as an 8×8 luma block. The sub-image-block obtained by dividing the luma component of the to-be-encoded image block in the block16×16 division mode is referred to as a 16×16 luma block. The sub-image-block corresponding to the chroma component of the to-be-encoded sub-image-block is referred to as a chroma block.

First, in embodiments of the present disclosure, hardware processing circuits (or referred to as hardware processing channels) are configured for the 4×4 luma block, the 8×8 luma block, and the 16×16 luma block. The above-described first division mode may correspond to block4×4, and the above-described second division mode may correspond to block16×16.

Since the to-be-encoded image block only includes a 16×16 luma block, the calculation process of the 16×16 luma block may be completed quickly. As shown in FIG. 7, after the calculation process of the 16×16 luma block is completed, the total division cost (for this example, since the to-be-encoded image block only includes a 16×16 luma block, the total division cost of the 16×16 luma block is equal to the matching cost of the 16×16 luma block) is used as the suspension threshold to control the calculation process of the other hardware processing channels. For example, when the current accumulated cost of the 8×8 luma blocks exceeds the total division cost of the 16×16 luma block, the calculation of the processing channels of the 8×8 luma blocks may be stopped to save the power consumption. Similarly, when the current accumulated cost of the 4×4 luma blocks exceeds the total division cost of the 16×16 luma block, the calculation of the processing channels of the 4×4 luma blocks may be stopped to save the power consumption.

Further, in some embodiments, the third processing circuit 330 may be further configured to perform the intraframe prediction on the chroma component of the to-be-encoded image block. Similarly, the fourth processing circuit 340 may further be configured to perform the quantization and the reconstruction on the chroma component of the to-be-encoded image block.

Compared to the first processing circuit 310, the third processing circuit 330 has fewer sub-image-blocks to process, and has less calculation load. In image encoding standard, compared with the to-be-processed luma blocks, a number of the to-be-processed chroma blocks is usually less. For H.264, the chroma block calculation is only performed on the block8×8. Therefore, embodiments of the present disclosure reuse the hardware resource to realize the calculation of the chroma block and the luma block in the second division mode. As shown in FIG. 6, after the 16×16 luma block is processed, the hardware process resource corresponding to the 16×16 luma block continues to process the chroma block. As such, the reuse rate of the hardware is improved, and the size of the chip is reduced.

Above-described embodiments improve the intraframe compression architecture in different ways. With the improved intraframe compression architecture, 4k resolution at 30 fps (4K@30fps) processing effect may be easily achieved by using TSMChpc28 nm process at 260 MHz frequency. Therefore, embodiments of the present disclosure may perform the intraframe compression with high quality and high hardware performance on the image with the low power consumption, without increasing the hardware frequency, and without increasing the area of the hardware.

Embodiments of the present disclosure further provide an image processing system. As shown in FIG. 8, an image processing system 800 includes the encoder 300 of any of the above-described embodiments.

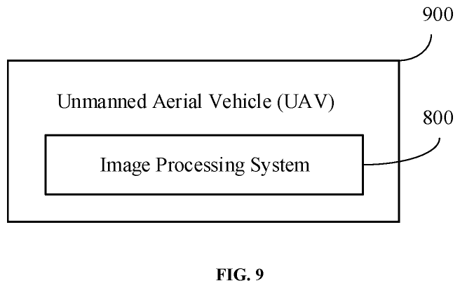

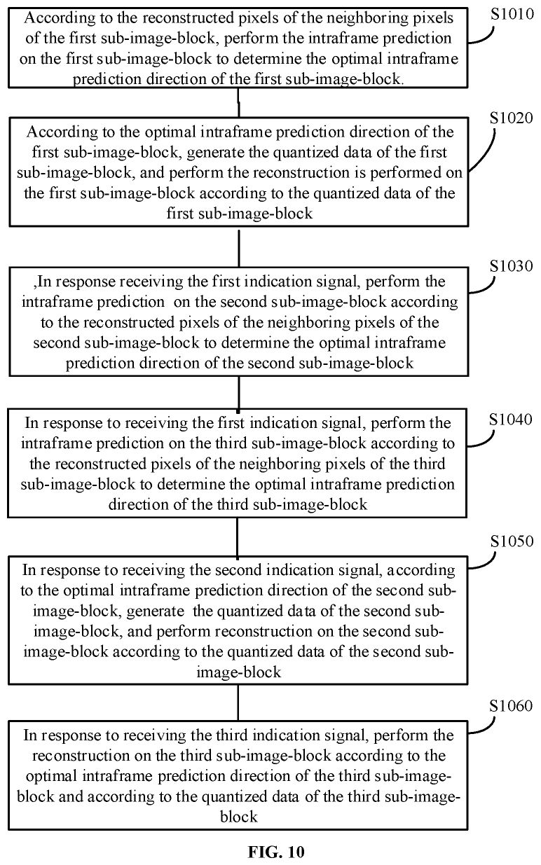

Embodiments of the present disclosure further provide a UAV. As shown in FIG. 9, a UAV 900 includes the image processing system 800 shown in FIG. 8.

In connection with FIG. 1 to FIG. 9, device embodiments of the present disclosure are described in detail. Method embodiments of the present disclosure are described in detail below in connection with FIG. 10. Method embodiments correspond to device embodiments. Therefore, for the parts not described in detail, reference may be made to above-described device embodiments.

FIG. 10 illustrates a schematic flowchart of an encoding method according to some embodiments of the present disclosure. In FIG. 10, the encoding method includes processes S1010-S1060.

At S1010, according to the reconstructed pixels of the neighboring pixels of the first sub-image-block, the intraframe prediction is performed on the first sub-image-block to determine the optimal intraframe prediction direction of the first sub-image-block. The first sub-image-block is a sub-image-block of the to-be-encoded image in the first division mode.

At S1020, according to the optimal intraframe prediction direction of the first sub-image-block, the quantized data of the first sub-image-block is generated, and the reconstruction is performed on the first sub-image-block according to the quantized data of the first sub-image-block.

At S1030, in response receiving the first indication signal, the intraframe prediction is performed on the second sub-image-block according to the reconstructed pixels of the neighboring pixels of the second sub-image-block to determine the optimal intraframe prediction direction of the second sub-image-block. The first indication signal indicates the completion of the reconstruction of the first sub-image-block.

At S1040, in response to receiving the first indication signal, the intraframe prediction is performed on the third sub-image-block according to the reconstructed pixels of the neighboring pixels of the third sub-image-block to determine the optimal intraframe prediction direction of the third sub-image-block.

The second sub-image-block and the third sub-image-block are sub-image-blocks of the to-be-encoded image block in the first division mode. The second sub-image-block is the right sub-image-block of the first sub-image-block. The third sub-image-block is the bottom left sub-image-block of the first sub-image-block.

At S1050, in response to receiving the second indication signal, according to the optimal intraframe prediction direction of the second sub-image-block, the quantized data of the second sub-image-block is generated, and reconstruction is performed on the second sub-image-block according to the quantized data of the second sub-image-block. The second indication signal indicates the completion of the intraframe prediction of the second sub-image-block.

At S1060, in response to receiving the third indication signal, the reconstruction is performed on the third sub-image-block according to the optimal intraframe prediction direction of the third sub-image-block and according to the quantized data of the third sub-image-block. The third indication signal indicates the completion of the intraframe prediction of the third sub-image-block.

In some embodiments, the intraframe prediction processes of the second sub-image-block and the third sub-image-block are performed in parallel.

In some embodiments, the to-be-encoded image block may include a 16×16 image block. The first division mode may include the 4×4 division mode. The first sub-image-block is any one of the image blocks of the sub-image-blocks numbered 1, 3, 4, 6, 9, and 12 of the 16×16 image block.

In some embodiments, the encoding method further includes performing the intraframe prediction on each of the sub-image-blocks of the to-be-encoded image in the second division mode, performing the quantization and the reconstruction on each of the sub-image-blocks of the to-be-encoded image in the second division mode, and when the current division cost of the to-be-encoded image block corresponding to the first division mode is greater than or equal to the total division cost of the to-be-encoded image block corresponding to the second division mode, stopping processing the to-be-encoded image block. The size of the sub-image-block obtained by division under the second division mode is greater than the size of the sub-image-block obtained by division under the first division mode.

In some embodiments, the to-be encoded image block is a 16×16 image block. The first division mode is the 4×4 division mode. The second division mode is the 16×16 division mode.

All or some of above-described embodiments may be implemented by software, hardware, firmware, or any other combinations. When embodiments are implemented by using software, all or some embodiments may be implemented in the form of a computer program product. The computer program product includes one or more computer instructions. When the computer program instructions are loaded and executed by the computer, all or some of the processes or functions according to embodiments of the present disclosure are generated. The computer may be a general-purpose computer, a dedicated computer, a computer network, or other programmable devices. The computer instructions may be stored in a computer-readable storage medium or transferred from one computer-readable storage medium to another computer-readable storage medium, for example, the computer instructions may be transmitted from a website site, computer, server or data center to another website, computer, server or data center through wired (such as coaxial cable, optical fiber, digital subscriber line (DSL)) or wireless (such as infrared, wireless, microwave, etc.) manners. The computer-readable storage medium may be any available medium that can be accessed by a computer or a data storage device of a server, a data center, etc., that is integrated by one or more applicable media. The applicable medium may include a magnetic medium (e.g., floppy disk, hard disk, magnetic tape), an optical medium (e.g., digital video disc (DVD)), or a semiconductor medium (e.g., solid-state disk (SSD)), etc.

Those of ordinary skill in the art may realize that the units and algorithm processes of the examples described in connection with embodiments disclosed herein may be implemented by electronic hardware, or a combination of computer software and electronic hardware. Whether these functions are executed in hardware or software depends on the specific application of the technical solution and design limitation. Those of skill in the art may use different methods to implement the described functions for each specific application, but such implementation should not be considered to be beyond the scope of the present disclosure.

In embodiments of the present disclosure, the disclosed system, device, and method may be implemented in other manners. For example, the device embodiments described above are only schematic. For example, the division of the units is only a division of logical functions. In actual implementation, other divisions may be applied. For example, a plurality of units or components may be combined or be integrated into another system, or some features may be ignored, or not implemented. In addition, the displayed or discussed mutual coupling or direct coupling or communication connection may be indirect coupling or communication connection through some interfaces, devices, or units, and may be electrical, mechanical, or other forms.

The units described as separate components may or may not be physically separated, and the components displayed as units may or may not be physical units. That is, they may be located in one place or may be distributed on multiple network units. Some or all of the units may be selected according to actual needs to achieve the objective of the solution of the present embodiments.

In addition, the functional units in embodiments of the present disclosure may be integrated into one processing unit, or each unit may exist alone physically, or two or more units may be integrated into one unit.

Above-described embodiments are only some embodiments of the present disclosure, but the scope of the present disclosure is not limited to this. Those skilled in the art can easily think of modifications or replacements within the technical scope disclosed in the present disclosure, which should be within the scope of the present disclosure. The scope of the invention shall be subject to the scope of the claims.

What is claimed is:

1. An encoder comprising:
a first processing circuit configured to perform intraframe prediction on a sub-image-block according to reconstructed neighboring pixels of the sub-image-block to determine an optimal intraframe prediction direction of the sub-image-block, the sub-image-block being one of sub-image-blocks for processing obtained by dividing a to-be-encoded image block in a division mode; and
a second processing circuit configured to:
generate quantized data of the sub-image-block according to the optimal intraframe prediction direction of the sub-image-block; and
perform reconstruction on the sub-image-block according to the quantized data of the first sub-image-block.

2. The encoder of claim 1, wherein:
the sub-image-block is a first sub-image-block;
the first processing circuit is further configured to, in response to receiving a first indication signal indicating completion of the reconstruction of the first sub-image-block by the second processing circuit, perform intraframe prediction on a second sub-image-block according to reconstructed neighboring pixels of the second sub-image-block to determine an optimal intraframe prediction direction of the second sub-image-block, the second sub-image-block being another one of the sub-image-blocks for processing and being right to the first sub-image-block; and
the second processing circuit is further configured to, in response to reception of a second indication signal indicating completion of the reconstruction of the second sub-image-block:
generate quantized data of the second sub-image-block according to the optimal intraframe prediction direction of the second sub-image-block; and
perform reconstruction on the second sub-image-block according to the quantized data of the second sub-image-block.

3. The encoder of claim 2, wherein:
the first processing circuit is further configured to, in response to receiving the first indication signal, perform intraframe prediction on a third sub-image-block according to reconstructed neighboring pixels of the third sub-image-block to determine an optimal intraframe prediction direction of the third sub-image-block, the third sub-image-block being a further one of the sub-image-blocks for processing and being bottom left to the first sub-image-block; and
the second processing circuit is further configured to, in response to receiving a third indication signal indicating completion of the intraframe prediction of the third sub-image-block:
generate quantized data of the third sub-image-block according to the optimal intraframe prediction direction of the third sub-image-block; and
perform reconstruction on the third sub-image-block according to the quantized data of the third sub-image-block.

4. The encoder of claim 3, wherein the first processing circuit is further configured to, in response to receiving the first indication signal, perform the intraframe prediction on the second sub-image-block and the intraframe prediction on the third sub-image-block in parallel.

5. The encoder of claim 1, wherein:
the to-be-encoded image block includes a 16×16 image block;
the division mode includes a 4×4 division mode; and
the sub-image-block includes any one of the sub-image-blocks numbered 1, 3, 4, 6, 9, and 12 of the 16×16 image block.

6. The encoder of claim 1, further comprising:
a third processing circuit; and
a fourth processing circuit;
wherein:
the division mode is a first division mode and the sub-image-blocks for processing are first sub-image-blocks for processing;
the third processing circuit is configured to perform intraframe prediction on each of second sub-image-blocks for processing obtained by dividing the to-be-encoded image block in a second division mode, sizes of the second sub-image-blocks for processing being larger than sizes of the first sub-image-blocks for processing;
the fourth processing circuit is configured to perform quantization and reconstruction on each of the second sub-image-blocks; and
at least one of the first processing circuit or the second processing circuit is further configured to stop processing the to-be-encoded image block in response to a current division cost corresponding to the to-be-encoded image block under the first division mode being greater than or equal to a total division cost corresponding to the to-be-encoded image block under the second division mode.

7. The encoder of claim 6, wherein:
the to-be-encoded image block includes a 16×16 image block;
the first division mode includes a 4×4 division mode; and
the second division mode includes a 16×16 division mode.

8. The encoder of claim 6, wherein:
the first processing circuit and the third processing circuit are configured to perform intraframe prediction on a luma component of the to-be-encoded image block; and
the third processing circuit is further configured to perform intraframe prediction on a chroma component of the to-be-encoded image block.

9. An image processing system comprising the encoder of claim 1.

10. An unmanned aerial vehicle (UAV) comprising an image processing system including:
an encoder including:
a first processing circuit configured to perform intraframe prediction on a sub-image-block according to reconstructed neighboring pixels of the sub-image-block to determine an optimal intraframe prediction direction of the sub-image-block, the sub-image-block being one of sub-image-blocks for processing obtained by dividing a to-be-encoded image block in a division mode; and
a second processing circuit configured to:
generate quantized data of the sub-image-block according to the optimal intraframe prediction direction of the sub-image-block; and
perform reconstruction on the sub-image-block according to the quantized data of the sub-image-block.

11. The UAV of claim 10, wherein:
the sub-image-block is a first sub-image-block;
the first processing circuit is further configured to, in response to receiving a first indication signal indicating completion of the reconstruction of the first sub-image-block by the second processing circuit, perform intraframe prediction on a second sub-image-block according to reconstructed neighboring pixels of the second sub-image-block to determine an optimal intraframe prediction direction of the second sub-image-block, the second sub-image-block being another one of the sub-image-blocks for processing and being right to the first sub-image-block; and
the second processing circuit is further configured to, in response to reception of a second indication signal indicating completion of the reconstruction of the second sub-image-block:
generate quantized data of the second sub-image-block according to the optimal intraframe prediction direction of the second sub-image-block; and
perform reconstruction on the second sub-image-block according to the quantized data of the second sub-image-block.

12. The UAV of claim 11, wherein:
the first processing circuit is further configured to, in response to receiving the first indication signal, perform intraframe prediction on a third sub-image-block according to reconstructed neighboring pixels of the third sub-image-block to determine an optimal intraframe prediction direction of the third sub-image-block, the third sub-image-block being a further one of the sub-image-blocks for processing and being bottom left to the first sub-image-block; and
the second processing circuit is further configured to, in response to receiving a third indication signal indicating completion of the intraframe prediction of the third sub-image-block:
generate quantized data of the third sub-image-block according to the optimal intraframe prediction direction of the third sub-image-block; and
perform reconstruction on the third sub-image-block according to the quantized data of the third sub-image-block.

13. An encoding method comprising:
performing intraframe prediction on a sub-image-block according to reconstructed neighboring pixels of the sub-image-block to determine an optimal intraframe prediction direction of the sub-image-block, the sub-image-block being one of sub-image-blocks for processing obtained by dividing a to-be-encoded image block in a division mode; and
generating quantized data of the sub-image-block according to the optimal intraframe prediction direction of the sub-image-block; and
performing reconstruction on the sub-image-block according to the quantized data of the first sub-image-block.

14. The encoding method of claim 13, wherein the sub-image-block is a first sub-image-block, the method further includes:
in response to receiving a first indication signal indicating completion of the reconstruction of the first sub-image-block by the second processing circuit, performing intraframe prediction on a second sub-image-block according to reconstructed neighboring pixels of the second sub-image-block to determine an optimal intraframe prediction direction of the second sub-image-block, the second sub-image-block being another one of the sub-image-blocks for processing and being right to the first sub-image-block; and
in response to reception of a second indication signal indicating completion of the reconstruction of the second sub-image-block:
generating quantized data of the second sub-image-block according to the optimal intraframe prediction direction of the second sub-image-block; and
performing reconstruction on the second sub-image-block according to the quantized data of the second sub-image-block.

15. The encoding method of claim 14, further comprising:
in response to receiving the first indication signal, performing intraframe prediction on a third sub-image-block according to reconstructed neighboring pixels of the third sub-image-block to determine an optimal intraframe prediction direction of the third sub-image-block, the third sub-image-block being a further one of the sub-image-blocks for processing and being bottom left to the first sub-image-block; and
in response to receiving a third indication signal indicating completion of the intraframe prediction of the third sub-image-block:
generating quantized data of the third sub-image-block according to the optimal intraframe prediction direction of the third sub-image-block; and
performing reconstruction on the third sub-image-block according to the quantized data of the third sub-image-block.

16. The encoding method of claim 15, further comprising, in response to receiving the first indication signal, performing the intraframe prediction on the second sub-image-block and the intraframe prediction on the third sub-image-block in parallel.

17. The encoding method of claim 13, wherein:
the to-be-encoded image block includes a 16×16 image block;
the first division mode includes a 4×4 division mode; and
the first sub-image-block includes any one of the sub-image-blocks numbered 1, 3, 4, 6, 9, and 12 of the 16×16 image block.

18. The encoding method of claim 13, wherein the division mode is a first division mode and the sub-image-blocks for processing are first sub-image-blocks for processing, the method further includes:
performing intraframe prediction on each of second sub-image-blocks for processing obtained by dividing the to-be-encoded image block in a second division mode, sizes of the second sub-image-blocks for processing being larger than sizes of the first sub-image-blocks for processing;
performing quantization and reconstruction on each of the second sub-image-blocks; and
stopping processing the to-be-encoded image block in response to a current division cost corresponding to the to-be-encoded image block under the first division mode being greater than or equal to a total division cost corresponding to the to-be-encoded image block under the second division mode.

19. The encoding method of claim 18, wherein:
the to-be-encoded image block includes a 16×16 image block;
the first division mode includes a 4×4 division mode; and
the second division mode includes a 16×16 division mode.
